(19) United States
(12) Patent Application Publication
(10) Pub. No.: US 2003/0023803 A1
(43) Pub. Date: Jan. 30, 2003

(54) Bus bridge circuit including audio logic and an addressable register for storing an address bit used when the audio logic accesses digital data, and method for initializing a chip set including the bus bridge circuit

(76) Inventor: Richard A. Zatorski, Pleasanton, CA (US)

Correspondence Address: WILLIAMS, MORGAN & AMERSON, P.C., 10333 RICHMOND, SUITE 1100, HOUSTON, TX, 77042, US

(21) Appl. No.: 09/912,745

(22) Filed: Jul. 24, 2001

(51) Int. Cl. G06F 13/00

(52) U.S. Cl. 710/306

(57) ABSTRACT

A bus bridge circuit adapted for coupling to a bus comprising n address lines, where n is an integer and n≧2. The bus bridge circuit includes audio logic configured to access digital audio data and to produce an n-1 bit address when accessing the digital audio data, and an addressable register including a bit position for storing an additional address bit. When the audio logic is accessing digital audio data, the bus bridge circuit is configured to: (i) concatenate the additional address bit with the n-1 bit address to produce an n-bit address, wherein the additional address bit forms a most significant bit of the n-bit address, and (ii) drive the n-bit address upon the n address lines of the bus. A computer system is described including the bus, wherein the bus bridge circuit is coupled to the bus. A method for initializing a chip set of a computer system is also described, wherein the chip set comprises the bus bridge circuit coupled to the bus. A carrier medium embodying program instructions for carrying out the above method is also described. The carrier medium may be, for example, a computer-readable storage medium (e.g., a floppy disk, or a compact disk read it only memory or CD-ROM disk).

### BACKGROUND OF THE INVENTION

1. Field of the Invention

This invention relates generally to computer systems, and, more particularly, to computer systems including multiple buses and bus bridge circuits for coupling one bus to another.

2. Description of the Related Art

A typical computer system includes multiple buses, each conveying different signals and having different timings and protocols. Computer system components are typically coupled to one of the buses, and “bridge logic” is used to couple one bus to another. The bridge logic translates signals between the coupled buses, allowing the components of the computer system to communicate with one another.

For example, the typical computer system may include a central processing unit (CPU) and a memory coupled to a processor bus. A first bus bridge circuit called a “north” bridge may couple the processor bus to a first peripheral bus (e.g., a peripheral component interconnect or PCI bus). One or more devices may be coupled to the first peripheral bus. The CPU and the devices may communicate with one another via the processor bus, the “north” bridge, and the first peripheral bus.

The typical computer system may also include a second bus bridge circuit called a “south” bridge coupled between the first peripheral bus and a second peripheral bus (e.g., an industry standard architecture or ISA bus). Additional devices may be coupled to the second peripheral bus. The CPU, the devices coupled to the first peripheral bus, and the additional devices coupled to the second peripheral bus may communicate with one another via the processor bus, the “north” bridge, the first peripheral bus, the “south” bridge, and the second peripheral bus.

Modern “south” bridges include control logic for controlling various peripheral devices. For example, known “south” bridges include an integrated drive electronics (IDE) controller for coupling to one or more IDE devices, a floppy disk (FD) controller for coupling to one or more floppy disk drives, a keyboard controller for coupling to a keyboard, and a mouse controller for coupling to a mouse. Known “south” bridges also include a parallel port (PP) controller for coupling to one or more parallel port devices, and two serial port (SP) controllers for coupling to serial port devices.

Known “south” bridges also include audio logic, and are adapted for coupling to a speaker and/or an audio signal source (e.g., an external audio device, a CD-ROM drive of the computer system, or a microphone). The audio logic may receive digital audio data, convert the digital audio data to an analog signal, and provide the analog signal to the speaker. The audio logic may also receive an analog audio signal from the audio signal source, convert the analog signal to digital audio data representing the analog audio signal, and store the digital audio data in the memory.

At least one known type of “south” bridge circuit includes audio logic and is adapted for coupling to a bus having n address lines. When the audio logic accesses digital audio data, the “south” bridge circuit drives an n-bit address upon the bus. However, the audio logic produces only the n-1 least significant bits of the n-bit address. The value of the most significant bit of the n-bit address is determined by electrically connecting a terminal of the “south” bridge circuit to one of two different voltage levels. Connecting the terminal to one of the two voltage levels results in addresses produced by the “south” bridge circuit residing in a lower half of an address space of the bus, and connecting the terminal to the other voltage level results in addresses produced by the “south” bridge circuit residing in an upper half of an address space of the bus.

A problem arises when employing the above type of “south” bridge circuit in a computer system in that once the terminal of the “south” bridge circuit is connected to one of the two voltage levels, the half of the address space of the bus in which addresses produced by the “south” bridge reside is so difficult to change as to reasonably be considered fixed. The present invention is directed to a system and method that solves this problem.

### SUMMARY OF THE INVENTION

A bus bridge circuit is described, wherein the bus bridge circuit is adapted for coupling to a first bus comprising n address lines, where n is an integer and n≧2. The bus bridge circuit includes audio logic configured to access digital audio data and to produce an n-1 bit address when accessing the digital audio data, and an addressable register including a bit position for storing an additional address bit. When the audio logic is accessing digital audio data, the bus bridge circuit is configured to: (i) concatenate the additional address bit with the n-1 bit address to produce an n-bit address, wherein the additional address bit forms a most significant bit of the n-bit address, and (ii) drive the n-bit address upon the n address lines of the first bus. A computer system is described including the first bus, wherein the bus bridge circuit is coupled to the first bus.

The addressable register has an address, and a value may be stored in the addressable register via a write operation specifying the address of the addressable register. The n address lines of the first bus define an address space of the first bus. A bit stored in the bit position of the addressable register (e.g., via a write operation) determines whether the n-bit address produced by the bus bridge circuit resides in a lower portion of the address space of the first bus, or in an upper portion of the address space of the first bus.

The bus bridge circuit may further be adapted for coupling to a second bus, and the bus bridge circuit may be configured to translate signals between the first bus and the second bus. The first bus may be, for example, a peripheral component interconnect (PCI) bus having n multiplexed address/data lines, and the second bus may be an industry standard architecture (ISA) bus.

The audio logic may be adapted for coupling to a speaker, and the audio logic may be configured to receive digital audio data, to transform the digital audio data to an analog signal, and to provide the analog signal to the speaker. The audio logic may also be adapted for coupling to a microphone, and the audio logic may be configured to receive an analog signal from the microphone, to transform the analog signal to digital audio data representing the analog signal, and to provide the digital audio data (e.g., to a memory).

A method is described for initializing a chip set of a computer system, wherein the chip set includes the above bus bridge circuit coupled to the first bus. A designated “target” portion of an address space of the first bus is either: (i) a lower half of the address space of the first bus, or (ii) an upper half of the address space of the first bus. The method includes initializing the bit position of the addressable register to a default value (e.g., a logic ‘0’). For example, when electrical power is applied to the bus bridge circuit, the addressable register may be hardware initialized such that the default value is stored in the bit position of the addressable register providing the additional address bit. Alternately, the addressable register may be initialized by software such that the default value is stored in the bit position of the addressable register providing the additional address bit.

Subsequently, the value of the bit position of the addressable register is changed (e.g., to a logic ‘1’) if it is determined that the default value will cause the bus bridge circuit to produce addresses which do not reside in the target portion of the address space of the first bus when the audio logic accesses digital audio data.

A carrier medium embodying program instructions for carrying out the above method is also described. The carrier medium may be, for example, a computer-readable storage medium (e.g., a floppy disk, or a compact disk read only memory or CD-ROM disk).

### BRIEF DESCRIPTION OF THE DRAWINGS

The invention may be understood by reference to the following description taken in conjunction with the accompanying drawings, in which like reference numerals identify similar elements, and in which:

FIG. 1 is a diagram of one embodiment of a computer system a peripheral component interconnect (PCI) bus, an industry standard architecture (ISA) bus, and a “south” bridge coupled between the PCI bus and the ISA bus;

FIG. 2 is a diagram of one embodiment of the south bridge of FIG. 1, wherein the south bridge includes audio logic configured to access digital audio data and to produce an n-1 bit address when accessing the digital audio data, and an addressable register including a bit position for storing an additional address bit; and

FIG. 3 is a flow chart of one embodiment of a method for initializing a chip set of the computer system of FIG. 1, wherein the chip set includes the south bridge of FIG. 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

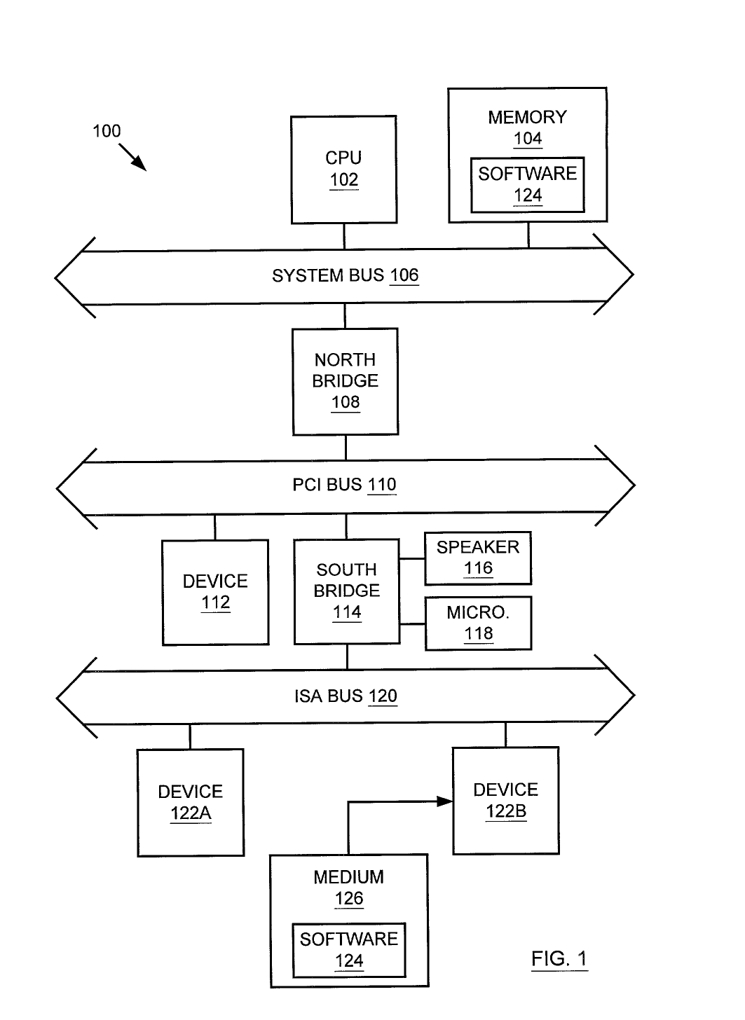

FIG. 1 is a diagram of one embodiment of a computer system 100 including a central processing unit (CPU) 102 and a memory 104 coupled to a system bus 106. A “north” bridge 108 is coupled between the system bus 106 and a peripheral component interconnect (PCI) bus 110. A device 112 is coupled to the PCI bus 110, and a “south” bridge 114 is coupled between the PCI bus 110 and an industry standard architecture (ISA) bus 120. A speaker 116 and a microphone 118 are coupled to the south bridge 114. A first device 122A and a second device 122B are coupled to the ISA bus 120.

In the embodiment of FIG. 1, the north bridge 108 translates signals between the system bus 106 and the PCI bus 110. The south bridge 114 translates signals between the PCI bus 110 and the ISA bus 120. The device 112 may be, for example, a communication device (e.g., a modem or a network adapter) or an input/output device (e.g., a monitor). The devices 122A and 122B may be, for example, storage devices (e.g., hard disk drives, floppy disk drives, or compact disk read only memory or CD-ROM drives) or input/output devices (e.g., modems, keyboards, pointing devices, or printers).

The CPU 102 executes instructions stored in the memory 104. As indicted in FIG. 1, the memory 104 includes software 124. The software 124 includes instructions executable by the CPU 102. As will be described in detail below, the software 124 includes instructions which, when executed by the CPU 102, configure hardware within the south bridge 114.

A carrier medium 126 in FIG. 1 is used to convey the software 124 to the memory 104. The instructions of the software 124 may be read from the carrier medium 126 via the device 122B (e.g., by the CPU 102) and stored in the memory 124. For example, the device 122B may be a disk drive for receiving removable disks (e.g., a floppy disk drive, a compact disk read only memory or CD-ROM drive, etc.), and the carrier medium 126 may be a disk (e.g., a floppy disk, a CD-ROM disk, etc.) embodying the software 124. Alternately, the carrier medium 126 may be a signal (e.g., a digital or analog signal) used to convey the instructions of the software 124. For example, the device 122B be a communication device (e.g., a modem), and the carrier medium 126 may be a signal (e.g., an electrical or optical signal) conveyed via a transmission medium to the device 122B.

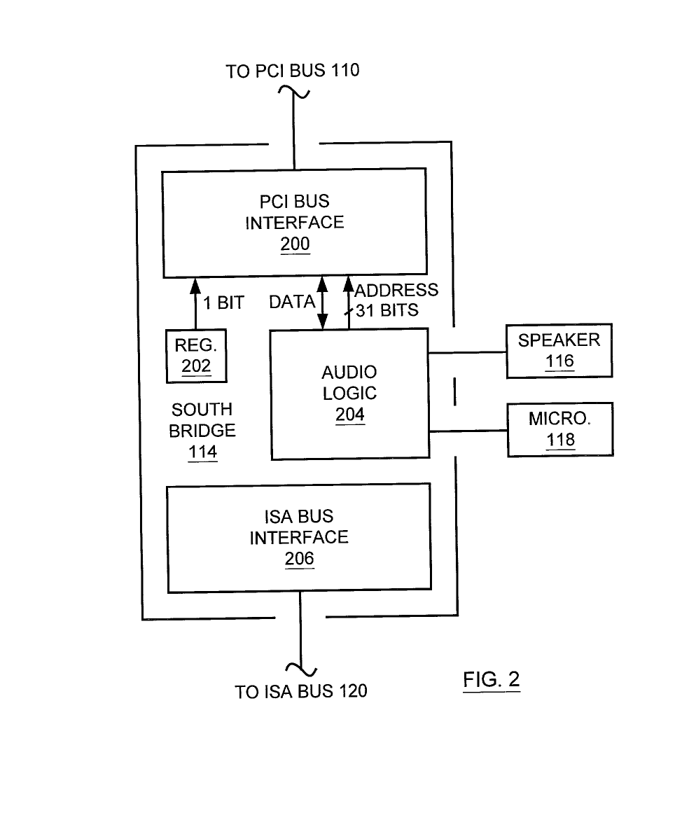

FIG. 2 is a diagram of one embodiment of the south bridge 114 of FIG. 1. In the embodiment of FIG. 2, the south bridge includes a PCI bus interface 200 coupled to the PCI bus 110 (FIG. 1), a register 202, audio logic 204, and an ISA bus interface 206 coupled to the ISA bus 120 (FIG. 1). The PCI bus interface 200 drives signals upon the PCI bus 110 (FIG. 1), and receives signals driven upon the PCI bus 110, according to a protocol of the PCI bus 110. The ISA bus interface 206 drives signals upon the ISA bus 120 (FIG. 1), and receives signals driven upon the ISA bus 120, according to a protocol of the ISA bus 120.

In the embodiment of FIG. 2, the audio logic 204 is coupled to the speaker 116 and the microphone 118. The audio logic 204 receives digital audio data (e.g., from the memory 104 of FIG. 1), transforms the digital audio data to an analog signal, and provides the analog signal to the speaker 116. The audio logic 204 also receives an analog signal from the microphone 118, and transforms the analog signal to digital audio data representing the analog signal, and provides the digital audio data (e.g., to the memory 104 of FIG. 1).

Digital audio data is conveyed to and from the audio logic 204 via the PCI bus 110. As indicated in FIG. 2, the audio logic 204 generates a 31-bit address associated with digital audio data, and provides the 31-bit address and the data to the PCI bus interface 200. In a standard configuration, the PCI bus 110 includes 32 multiplexed address/data lines. For the PCI bus interface 200 to drive 32-bit addresses upon the PCI bus 110, a bit position of the register 202 is used to provide an additional address bit.

The register 202 is an addressable register (i.e., has an address), and may be read from or written to using the address. Register 202 may have a single bit position storing the additional address bit. In one embodiment, when electrical power is applied to the south bridge 114, the register 202 may be hardware initialized such that a logic ‘0’ is stored in the bit position of the register 202 providing the additional address bit. In other embodiments, the register 202 may be initialized by software (e.g., software 124 of FIG. 1) such that a logic ‘0’ is stored in the bit position of the register 202 providing the additional address bit.

When digital audio data is to be conveyed to or from by the audio logic 204 via the PCI bus 110, the audio logic 204 provides the 31-bit address associated with the digital audio data to the PCI bus interface 200. The PCI bus interface 200 also receives the additional address bit stored within the bit position of the register 202. The PCI bus interface 200 concatenates the additional address bit from the register 202 with the 31-bit address received from the audio logic 204 to produce a 32-bit address. The concatenation is performed such that the additional address bit from the register 202 forms a most significant (i.e., highest ordered) bit of the resulting 32-bit address. The PCI bus interface 200 then drives the 32-bit address upon the PCI bus 110.

For example, the audio logic 204 may include a direct memory access (DMA) controller, and digital audio data may be transferred between the audio logic 204 and the memory 104 (FIG. 1) via the DMA controller. The audio logic 204 may initiate a DMA transfer operation to provide digital audio data to the memory 104, or to obtain digital audio data from the memory 104. During the DMA transfer operation, the DMA controller may provide the 31-bit address to the PCI bus interface 200. The PCI bus interface 200 may receive the 31-bit address from the DMA controller, concatenate the additional address bit from the register 202 with the 31-bit address to produce a 32-bit address such that the additional address bit forms the most significant (i.e., highest ordered) bit of the 32-bit address, and drive the resulting 32-bit address upon the PCI bus 110.

It is noted that the register 202, providing the additional address bit, allows the audio logic 204 to store digital audio data in, or to obtain digital audio data from, memory locations of the memory 104 (FIG. 1) within the full 4 Gigabyte (2³² byte) address space of the PCI bus 110. It is also noted that as the additional address bit provided by the register 202 forms the most significant (i.e., highest ordered) bit of the resulting 32-bit address, the register 202 allows the audio logic 204 to selectively store digital audio data in, and/or to obtain digital audio data from, memory locations of the memory 104 (FIG. 1) within a lower or upper half of the address space of the PCI bus 110. Where the additional address bit is a logic ‘0’, the audio logic 204 may access memory locations within the lower half of the address space of the PCI bus 110. Where the additional address bit is a logic ‘1’, the audio logic 204 may access memory locations within the upper half of the address space of the PCI bus 110.

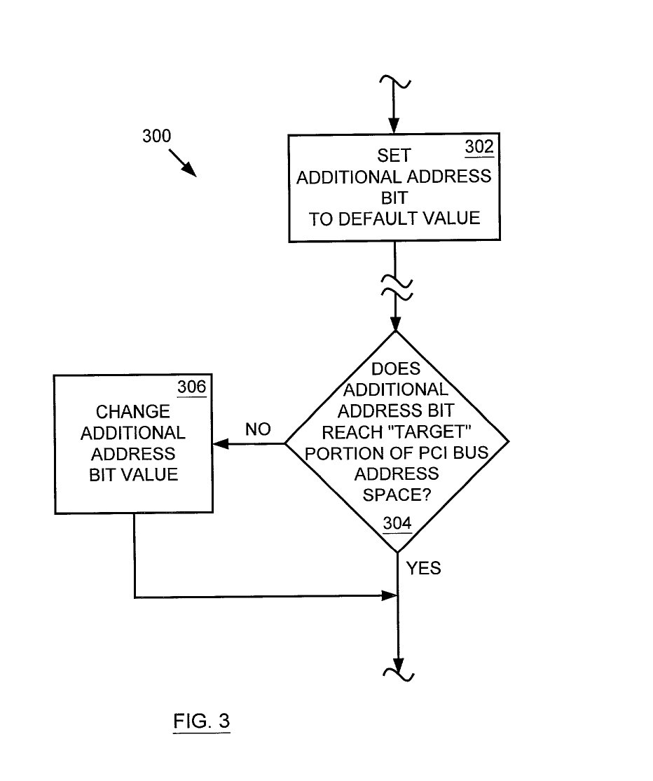

Referring back to FIG. 1, the north bridge 108 and the south bridge 114 are collectively referred to as a “chip set” of the computer system 100. FIG. 3 is a flow chart of one embodiment of a method 300 for initializing the chip set of the computer system 100 of FIG. 1, wherein the chip set includes the south bridge 114 of FIG. 2. The method 300 may be embodied within the software 124 of FIG. 1.

During a step 302, the bit position of the register 202 providing the additional address bit is initialized to a default value (e.g., a logic ‘0’). Such initialization of the register 202 may be accomplished via hardware or software as described above.

A designated “target” portion of the address space of the PCI bus 110 (FIG. 1) may be: (i) the lower half of the address space of the PCI bus 110, or (ii) the upper half of the address space of the PCI bus 110. Subsequent to the step 302, a decision step 304 is accomplished. During the decision step 304, if the default value of the bit position of the register 202 providing the additional address bit will cause the south bridge 114 to produce 32-bit addresses residing in the “target” portion of the address space of the PCI bus 110, the default value of the bit position of the register 202 providing the additional address bit is not changed.

On the other hand, if it is determined during the step 304 that the default value of the bit position of the register 202 providing the additional address bit will cause the south bridge 114 to produce 32-bit addresses which do not reside in the “target” portion of the address space of the PCI bus 110, a step 306 is accomplished. During the step 306, the default value of the bit position of the register 202 providing the additional address bit is changed (e.g., from a logic ‘0’ to a logic ‘1’) such that the south bridge 114 will produce 32-bit addresses residing in the “target” portion of the address space of the PCI bus 110.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A bus bridge circuit, wherein the bus bridge circuit is adapted for coupling to a first bus comprising n address lines, and wherein n is an integer and n≧2, and wherein the bus bridge circuit comprises:
audio logic configured to access digital audio data and to produce an n-1 bit address when accessing the digital audio data; and
an addressable register comprising a bit position for storing an additional address bit; and
wherein when the audio logic is accessing digital audio data, the bus bridge circuit is configured to: (i) concatenate the additional address bit with the n-1 bit address to produce an n-bit address, wherein the additional address bit forms a most significant bit of the n-bit address, and (ii) drive the n-bit address upon the n address lines of the first bus.

2. The bus bridge circuit as recited in claim 1, wherein the addressable register has an address, and wherein a value may be stored in the addressable register via a write operation specifying the address of the addressable register.

3. The bus bridge circuit as recited in claim 1, wherein the n address lines of the first bus define an address space of the first bus, and wherein a bit stored in the bit position of the addressable register via a write operation determines whether the n-bit address resides in a lower portion of the address space of the first bus, or in an upper portion of the address space of the first bus.

4. The bus bridge circuit as recited in claim 1, wherein the first bus is a peripheral component interconnect (PCI) bus having n multiplexed address/data lines.

5. The bus bridge circuit as recited in claim 1, wherein the bus bridge circuit is further adapted for coupling to a second bus, and wherein the bus bridge circuit is configured to translate signals between the first bus and the second bus.

6. The bus bridge circuit as recited in claim 5, wherein the first bus is a peripheral component interconnect (PCI) bus having n multiplexed address/data lines, and wherein the second bus is an industry standard architecture (ISA) bus.

7. The bus bridge circuit as recited in claim 1, wherein the audio logic is adapted for coupling to a speaker, and wherein the audio logic is configured to receive digital audio data, to transform the digital audio data to an analog signal, and to provide the analog signal to the speaker.

8. The bus bridge circuit as recited in claim 1, wherein the audio logic is adapted for coupling to a microphone, and wherein the audio logic is configured to receive an analog signal from the microphone, to transform the analog signal to digital audio data representing the analog signal, and to provide the digital audio data.

9. A computer system, comprising:
a first bus, wherein the first bus comprises n address lines, and wherein n is an integer and n≧2;
a bus bridge circuit coupled to the first bus, wherein the bus bridge circuit comprises:
audio logic configured to access digital audio data and to produce an n-1 bit address when accessing the digital audio data; and
an addressable register comprising a bit position for storing an additional address bit; and
wherein when the audio logic is accessing digital audio data, the bus bridge circuit is configured to: (i) concatenate the additional address bit with the n-1 bit address to produce an n-bit address, wherein the additional address bit forms a most significant bit of the n-bit address, and (ii) drive the n-bit address upon the n address lines of the first bus.

10. The computer system as recited in claim 9, wherein the addressable register has an address, and wherein a value may be stored in the addressable register via a write operation specifying the address of the addressable register.

11. The computer system as recited in claim 9, wherein the n address lines of the first bus define an address space of the first bus, and wherein a bit stored in the bit position of the addressable register via a write operation determines whether the n-bit address resides in a lower portion of the address space of the first bus, or in an upper portion of the address space of the first bus.

12. The computer system as recited in claim 9, wherein the first bus is a peripheral component interconnect (PCI) bus having n multiplexed address/data lines.

13. The computer system as recited in claim 9, further comprising a second bus, wherein the bus bridge circuit is coupled between the first bus and the second bus, and wherein the bus bridge circuit is configured to translate signals between the first bus and the second bus.

14. The computer system as recited in claim 13, wherein the first bus is a peripheral component interconnect (PCI) bus having n multiplexed address/data lines, and wherein the second bus is an industry standard architecture (ISA) bus.

15. The computer system as recited in claim 9, wherein the audio logic is adapted for coupling to a speaker, and wherein the audio logic is configured to receive digital audio data, to transform the digital audio data to an analog signal, and to provide the analog signal to the speaker.

16. The computer system as recited in claim 9, wherein the audio logic is adapted for coupling to a microphone, and wherein the audio logic is configured to receive an analog signal from the microphone, to transform the analog signal to digital audio data representing the analog signal, and to provide the digital audio data.

17. A computer system, comprising:
a first bus comprising n address lines, wherein n is an integer and n≧2;
a second bus;
a bus bridge circuit coupled between the first bus and the second bus, wherein the bus bridge circuit is configured to translate signals between the first bus and the second bus;
wherein the bus bridge circuit comprises:
audio logic configured to access digital audio data and to produce an n-1 bit address when accessing the digital audio data; and
an addressable register comprising a bit position for storing an additional address bit, wherein the addressable register has an address, and wherein a value may be stored in the addressable register via a write operation specifying the address of the addressable register; and
wherein when the audio logic is accessing digital audio data, the bus bridge circuit is configured to: (i) concatenate the additional address bit with the n-1 bit address to produce an n-bit address, wherein the additional address bit forms a most significant bit of the n-bit address, and (ii) drive the n-bit address upon the n address lines of the first bus.

18. The computer system as recited in claim 17, wherein the n address lines of the first bus define an address space of the first bus, and wherein a bit of a value stored in the bit position of the addressable register via a write operation determines whether the n-bit address resides in a lower portion of the address space of the first bus, or in an upper portion of the address space of the first bus.

19. A method for initializing a chip set of a computer system, wherein the chip set comprises a bus bridge circuit coupled to a bus and includes audio logic and an addressable register, and wherein the addressable register comprises a bit position providing an additional address bit, and wherein the bus bridge circuit produces addresses when the audio logic accesses digital audio data, and wherein the additional address bit forms a most significant bit of the addresses, the method comprising:
initializing the bit position of the addressable register to a default value; and
changing the value of the bit position of the addressable register if the default value will cause the bus bridge circuit to produce addresses which do not reside in a target portion of the address space of the bus when the audio logic accesses digital audio data.

20. The method as recited in claim 19, wherein changing the value of the bit position causes the target portion of the address space of the bus to be either: (i) a lower half of the address space of the bus, or (ii) an upper half of the address space of the bus.

21. The method as recited in claim 19, wherein initializing comprises:
initializing the bit position of the addressable register to a logic ‘0’ default value.

22. The method as recited in claim 21, wherein changing comprises:
changing the value of the bit position of the addressable register to a logic ‘1’ if the logic ‘0’ default value will cause the bus bridge circuit to produce addresses which do not reside in a target portion of the address space of the bus when the audio logic accesses digital audio data.

23. A carrier medium comprising program instructions for initializing a chip set of a computer system, wherein the chip set comprises a bus bridge circuit coupled to a bus and including audio logic and an addressable register, and wherein the addressable register comprises a bit position providing an additional address bit, and wherein the bus bridge circuit produces addresses when the audio logic accesses digital audio data, and wherein the additional address bit forms a most significant bit of the addresses, and wherein the program instructions are operable to implement:
initializing the bit position of the addressable register to a default value; and
changing the value of the bit position of the addressable register if the default value will cause the bus bridge circuit to produce addresses which do not reside in a target portion of the address space of the bus when the audio logic accesses digital audio data.

24. The carrier medium as recited in claim 23, wherein the carrier medium is a computer-readable storage medium.

25. The carrier medium as recited in claim 24, wherein the computer-readable storage medium is a floppy disk or a compact disk read only memory (CD-ROM) disk.
